(19) United States
(12) Patent Application Publication
(10) Pub. No.: US 2014/0192170 A1
(43) Pub. Date: Jul. 10, 2014

(54) Model-Based Stereoscopic and Multiview Cross-Talk Reduction

(71) Applicants: Ramin Samadani, Palo Alto, CA (US); Nelson Liang An Chang, San Jose, CA (US)

(72) Inventors: Ramin Samadani, Palo Alto, CA (US); Nelson Liang An Chang, San Jose, CA (US)

(21) Appl. No.: 14/237,439

(22) PCT Filed: Aug. 25, 2011
(86) PCT No.: PCT/US2011/049176

§ 371 Date: Feb. 6, 2014

(51) Int. Cl. H04N 13/00; H04N 13/04

(52) U.S. Cl. CPC H04N 13/0011; H04N 13/04
USPC 348/51

(57) ABSTRACT

A method for reducing cross-talk in a 3D display is disclosed. The cross-talk in the 3D display is characterized with a plurality of test signals to generate a forward transformation model. Input image signals are applied to the forward transformation model to generate modeled signals. The modeled signals are applied to a visual model to generate a visual measure. The input signals are modified based on the visual measure.

### BACKGROUND

Stereoscopic and multiview displays have emerged to provide viewers a more accurate visual reproduction of three-dimensional (“3D”) real-world scenes. Such displays may require the use of active glasses, passive glasses or autostereoscopic lenticular arrays to enable viewers to experience a 3D effect from multiple viewpoints. For example, stereoscopic displays direct a separate image view to the left and to the right eye of a viewer. The viewer's brain then compares the different views and creates what the viewer sees as a single 3D image.

One significant challenge that arises in 3D displays is cross-talk between the image views. That is, part of the image views intended for one eye bleeds or leaks through to the other eye resulting in undesired cross-talk signals. These cross-talk signals are superimposed to the image views thereby diminishing the overall quality of the 3D image. There have been various approaches to reduce and correct for cross-talk in 3D displays, but they tend to be limited to a specific type of content (e.g., graphics imagery), to a specific type of 3D display (e.g., those requiring active glasses), or to a small number of views (e.g., two views in case of stereo, in addition to being expensive to implement in hardware or in physics-based approaches.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates a schematic diagram of an example 3D display system with cross-talk;

FIG. 2 illustrates a schematic diagram of a system for characterizing and correcting for cross-talk signals in a 3D display;

FIG. 3 illustrates an example cross-talk reduction module of FIG. 2 in more detail;

FIG. 4 is a flowchart for reducing and correcting for cross-talk in a 3D display using the cross-talk reduction module of FIG. 3 in accordance with various embodiments;

FIG. 5 is a schematic diagram of as a forward transformation model for use with the cross-talk reduction module of FIGS. 3; and

FIG. 6 illustrates example test signals that may be used to generate the forward transformation model of FIG. 5.

### DETAILED DESCRIPTION

A model-based cross-talk reduction system and method for use with stereoscopic and multiview 3D displays are disclosed. As generally described herein, cross-talk occurs when an image signal or view intended for one viewer's eye appears as an unintended signal superimposed to an image signal intended for the other eye. The unintended signal is referred to herein as a cross-talk signal.

In various embodiments, cross-talk signals that appear in a 3D display are reduced and corrected for by using a forward transformation model and a visual model. The forward transformation model characterizes the optical, photometric, and geometric aspects of cross-talk signals that arise when image signals are input into the display. The visual model takes into account salient visual effects involving spatial discrimination, color, and temporal discrimination so that visual fidelity to the original image signals that are input into the display is maintained. A non-linear optimization is applied to the input signals to reduce or completely eliminate the cross-talk signals.

It is appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

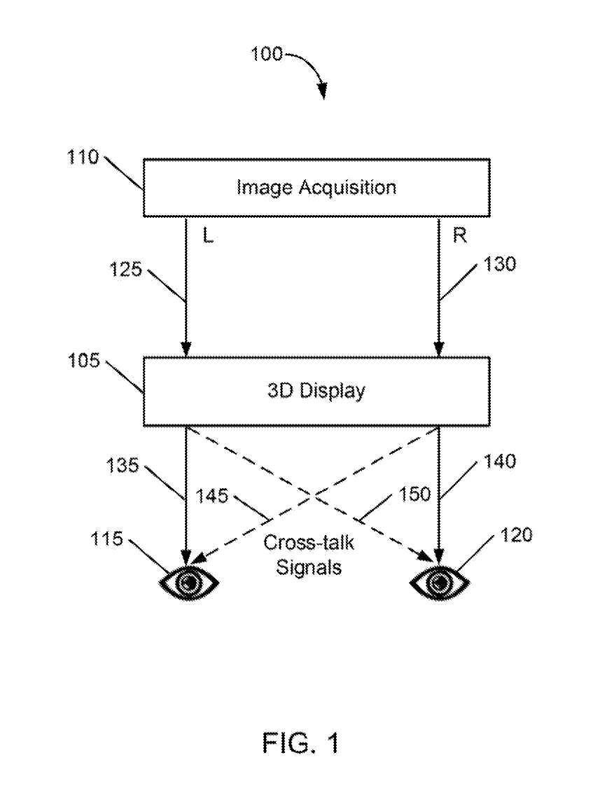

Referring now to FIG. 1, a schematic diagram of an example 3D display system with cross-talk is described. The 3D display system 100 has a 3D display screen 105 that may be a stereoscopic or multiview display screen, such as, for example, a parallax display, a lenticular-based display, a holographic display, a projector-based display, a light field display, and so on. An image acquisition module 110 may have one or more cameras (not shown) to capture multiple image views or signals for display in the display screen 105. For example, in case of a stereoscopic display, two image views may be captured, one for the viewer's left eye 115 (a left image “L” 125) and another for the viewer's right eye 120 (a right image “R” 130), The captured images 125-130 are displayed on the display screen 105 and perceived as image 135 in the viewer's left eye 115 and image 140 in the viewer's right eye 120. Alternately, the image acquisition module 110 may refer simply to computer generated 3D or multiview graphical information.

As a result of cross-talk generated by the display screen 105, the images 135-140 are superimposed with cross-talk signals. The image 135 for the viewer's left eye 115 is superimposed with a cross-talk signal 145 and the image 140 for the viewer's right eye 120 is superimposed with a cross-talk signal 150. As appreciated by one skilled in the art, the presence of the cross-talk signals 145 and 150 in the images perceived by the viewer affect the overall quality of the images. It is also appreciated that unlike ghosting or other subjective visible artifacts, the cross-talk signals are a physical entity and can be objectively measured, characterized, and corrected for.

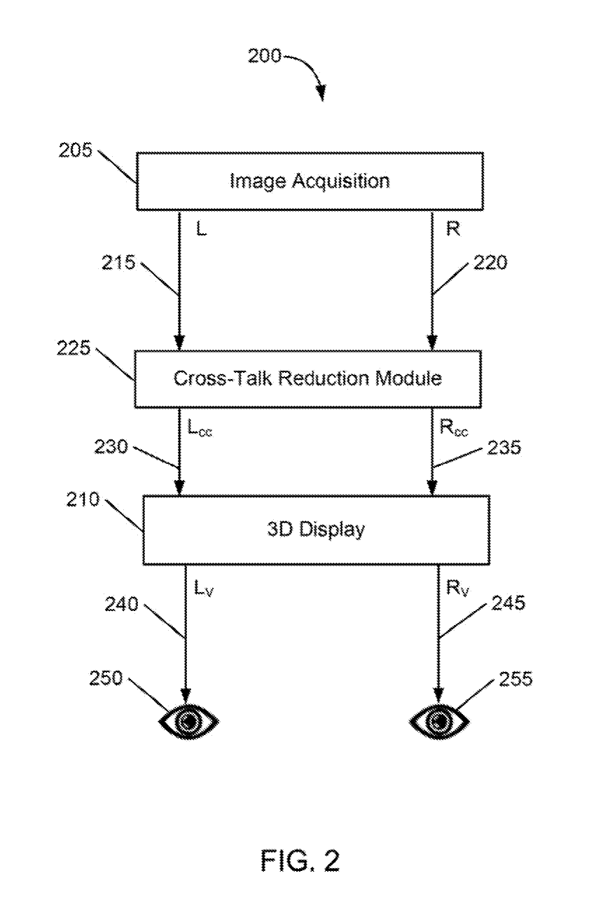

Referring now to FIG. 2, a schematic diagram of a system for characterizing and correcting for cross-talk signals in a 3D display is described. The 3D display system 200 has an image acquisition module 205 for capturing multiple image views or signals for display in the 3D display screen 210, such as for example, a left image “L” 215 and a right image “R” 220. A cross-talk reduction module 225 takes the images 215-220 and applies a model-based approach to reduce and correct for cross-talk introduced by the 3D display screen 210. The cross-talk reduction module 225 modifies the images 215-220 into images 230-235 that are then input into the display screen 210. As a result, images 240-245 are perceived by the viewer's eyes 250-255 with significantly reduced or non-existent cross-talk. It is appreciated by one skilled in the art that the cross-talk reduction module 225 and the 3D display screen 210 may be implemented in separate devices (as depicted) or integrated into a single device.

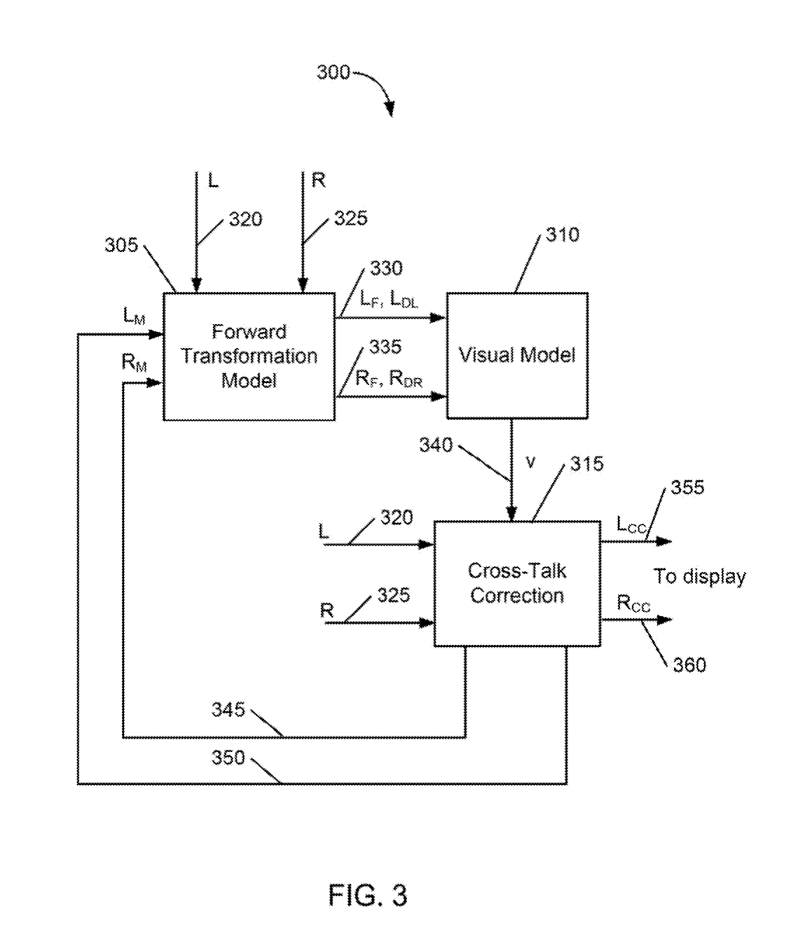

FIG. 3 illustrates an example cross-talk reduction module of FIG. 2 in more detail. The cross-talk reduction module 300 has a forward transformation model 305, a visual model 310 and a cross-talk correction module 315 to reduce and correct for cross-talk signals destined to a 3D display. Given multiple image views or signals to be displayed in the 3D display, such as, for example, a left image signal “L” 320 and a right image signal “R” 325, the cross-talk reduction module 300 characterizes the cross-talk introduced by the 3D display and generates corresponding cross-talk corrected images, such as a left cross-talk corrected image “L_{CC}” 355 and a right cross-talk corrected image “R_{CC}” 360.

The forward transformation model 305 characterizes the optical, photometric, and geometric aspects of direct and cross-talk signals that are introduced by the 3D display. That is, the forward transformation model 305 estimates or models the direct and cross-talk signals by characterizing the forward transformation from image acquisition image acquisition module 205 to 3D display (e.g., 3D display 210). This is done by measuring output signals generated by the 3D display when using test signals as an input. As appreciated by one skilled in the art, the forward transformation model 305 can be represented by a mathematical function F(.).

In various embodiments, the test signals may include both left and right test signals jointly, or individual left, and right, test signals. In the first case, test image signals L_{T} and R_{T} are jointly sent to the 3D display to generate left and right output signals, referred to herein as L_{F} and R_{F}, and estimate the parameters of the forward transformation function F(.). That is

F_{L}(L_{T},R_{T})→L_{F} (Eq. 1)

F_{R}(L_{T},R_{T})→R_{F} (Eq. 2)

where F_{L} represents the forward model used to characterize the left output signal L_{F} and F_{R} represents the forward model used to characterize the right output signal R_{F}.

In the second case, the test image signals L_{T} and R_{T} are separately sent to the 3D display to generate left and right output signals that are measured. That is:

F_{L}(L_{T},0)=L_{DC},R_{CL} (Eq. 3)

F_{R}(0,R_{T})=L_{CR},R_{DR} (Eq. 4)

where L_{DL} and R_{CL} are the output signals that would be displayed to the viewer's left (L_{DL}) and right (R_{CL}) eyes when only the L_{T} test signal is used as an input. Similarly, L_{CR} and R_{DR} are the output signals that would be displayed to the viewer's left (L_{CR}) and right (R_{DR}) eyes when only the R_{T} test signal is used as an input,

As appreciated by one skilled in the art, the L_{DL} and R_{DR} signals are the desired output signals at each eye in the absence of cross-talk, while the R_{CL} and L_{CR} signals represent the cross-talk that leaks to the other eye. For example, R_{CL} represents the cross-talk seen at the right eye when only the left image signal is sent to the display, while L_{CR} represents the cross-talk seen at the left eye when only the right image signal is sent to the display.

In one embodiment, an additive or other such model may be used to combine the measured responses for each eye, that is, to combine the L_{DL} and L_{CR} responses for the left eye into a combined signal L_{D} and to combine the R_{CL} and R_{DR} responses for the right eye into a combined signal 16. The combined responses L_{D} and R_{D} may then used to estimate the parameters of the forward transformation function F(.). Note that this transformation function is display-dependent, as its parameters vary depending on the particular 3D display being used (e.g., a lenticular array display, a stereoscopic active glasses display, as light field display, and so on).

Once the forward transformation model 305 is generated with the test signals, input image signals (e.g., L 320 and R 325) may be applied to the cross-reduction module 305 to generate cross-corrected image signals (e.g., L_{CC} 355 and R_{CC} 300). First, the L 320 and R 325 input signals are applied to the forward transformation model 305 to characterize the cross-talk introduced by the 3D display with modeled cross-talk output signals L_{F} and R_{F} and desired signals L_{DL} and R_{DR}. These signals are then sent to the visual model 310 to determine as visual measure representing how the visual quality of signals displayed in the 3D display is affected by its cross-talk. In one example, the visual model 310 computes a measure v of the visual differences between the desired signals L_{DL} and R_{DR} and the modeled cross-talk output signals L_{F} and R_{F} by taking into account visual effects involving spatial discrimination, color, and temporal discrimination, among others. It is appreciated that the visual model 310 may be any visual model for computing such a visual differences measure.

The cross-correction module 315 uses this measure v to modify the input image signals L 320 and R 325 to generate visually modified input signals L_{M} 345 and R_{M} 350. In one embodiment, this is done by varying visual parameters or characteristics such as contrast, brightness, and color of the input signals to generate the visually modified input signals as canonical transformations of the input signals.

The visually modified input signals L_{M} 345 and R_{M} 350 are then sent as inputs to the forward transformation model 305 to update the visual measure v and determine whether the modifications to the input signals reduced the cross-talk (the smaller the value of v, the lower the cross-talk). This process is repealed until the cross-talk is significantly reduced or completely eliminated, i.e., until it is visually reduced to a viewer. That is, a non-linear optimization is performed to iterate through values of v until v is minimized and the cross-talk is significantly reduced or completely eliminated in output signals L_{CC} 355 and R_{CC} 360. It is appreciated that the output signals L_{CC} 355 and R_{CC} 360 are the same as the visually modified signals L_{M} 345 and R_{M} 350 when the visual measure v is at its minimum.

It is also appreciated that the various left and right image signals illustrated in FIG. 3 (e.g., inputs L 320 and R 325, outputs L_{CC} 355 and R_{CC} 360) are shown for illustration purposes only Multiple image views may be input into the cross-talk reduction module 300 (such as, for example, the multiple image views in a multiview display) to generate corresponding cross-talk corrected outputs. That is, the cross-talk reduction module 300 may be implemented for any type of 3D display regardless of the number of views it supports.

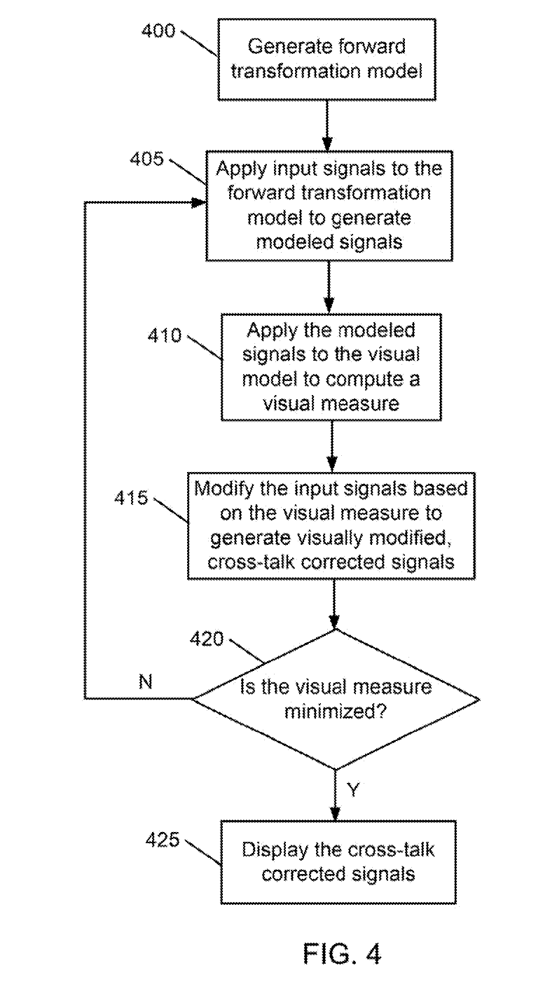

Attention is now directed to FIG. 4, which shows a flowchart for reducing and correcting for cross-talk in a 3D display using the cross-talk reduction module of FIG. 3 in accordance with various embodiments. First, the cross-talk introduced in the 3D display is characterized with a plurality of test signals to generate a forward transformation model (400). Once the forward transformation model is generated, image signals are input into the model to generate modeled signals (405). These modeled signals may be, for example, the L_{F} and R_{F} and L_{D} and R_{D} signals described above.

Next, the modeled signals are applied to the visual model to compute a visual measure indicating how the visual quality of signals displayed in the 3D display is affected by its cross-talk (410). The input signals are then modified based on the visual measure (415) and re-applied to the forward transformation model until the visual measure is minimized (420). Once the visual measure is minimized, the modified, cross-talk corrected signals are sent to the 3D display for display (425). The cross-talk corrected signals are such that cross-talk is visually reduced to a viewer. Alternatively, as appreciated by one skilled in the art, the modified, cross-talk corrected signals can be saved for later display.

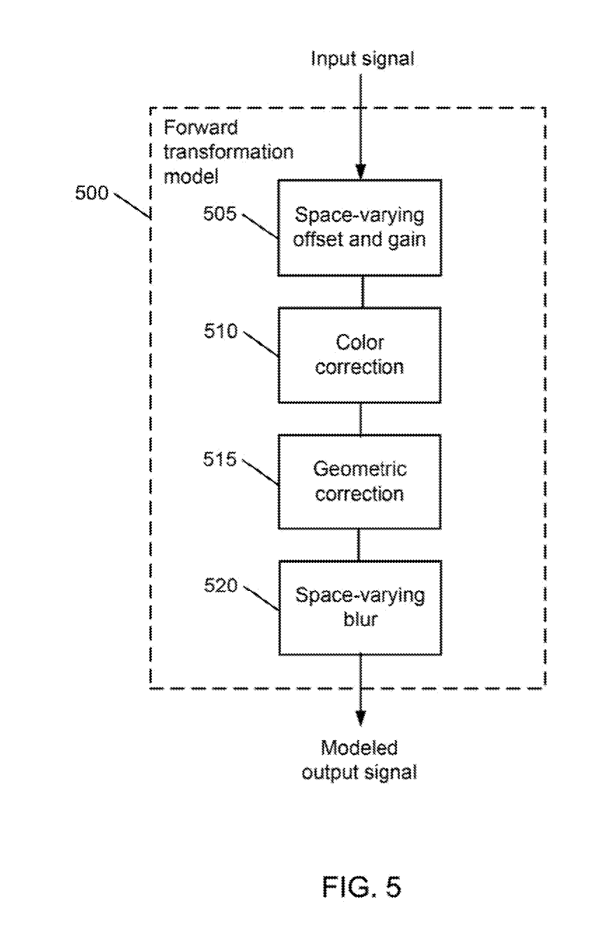

Referring now to FIG. 5, a schematic diagram of as forward transformation model for use with the cross-talk reduction module of FIG. 3 is described. The forward transformation model 500 has four main transformations to characterize the photometric, geometric, and optical factors represented in the forward transformation function F(.): (1) a space-varying offset and gain transformation 505; (2) a color correction transformation 510; (3) a geometric correction transformation 515; and (4) a space varying blur transformation 520. Test signals including color patches, grid patterns, horizontal and vertical stripes, and uniform white, black and gray level signals are sent to a 3D display in a dark room to estimate the parameters of F(.).

In the space-varying offset and gain transformation 505, white and black level signals are sent to the 3D display to determine its white and black responses and generate a gain offset output. Given this gain offset transformation, the color correction transformation 510 is determined next by fining between measured colors and color values. Measured average color values for gray input patches are used to determine one-dimensional look-up tables applied to input color components, and measured average color values for primary R, G, and B inputs are used to determine a color mixing matrix using the known input color values. Computing the fits using the spatially renormalized colors allows the color correction transformation 510 to fit the data using a small number of parameters.

Next, the geometric correction 515 may be determined using, for example, a polynomial mesh transformation model. The final space-varying blur transformation 520 is required to obtain good results at the edges of the modeled signals. If the blur is not applied, objectionable halo artifacts may remain visible in the modeled signal. In one embodiment, the parameters of the space-varying blur may be determined by estimating separate blur kernels in the horizontal and vertical directions. It is appreciated that additional transformations may be used to generate the forward transformation model 500.

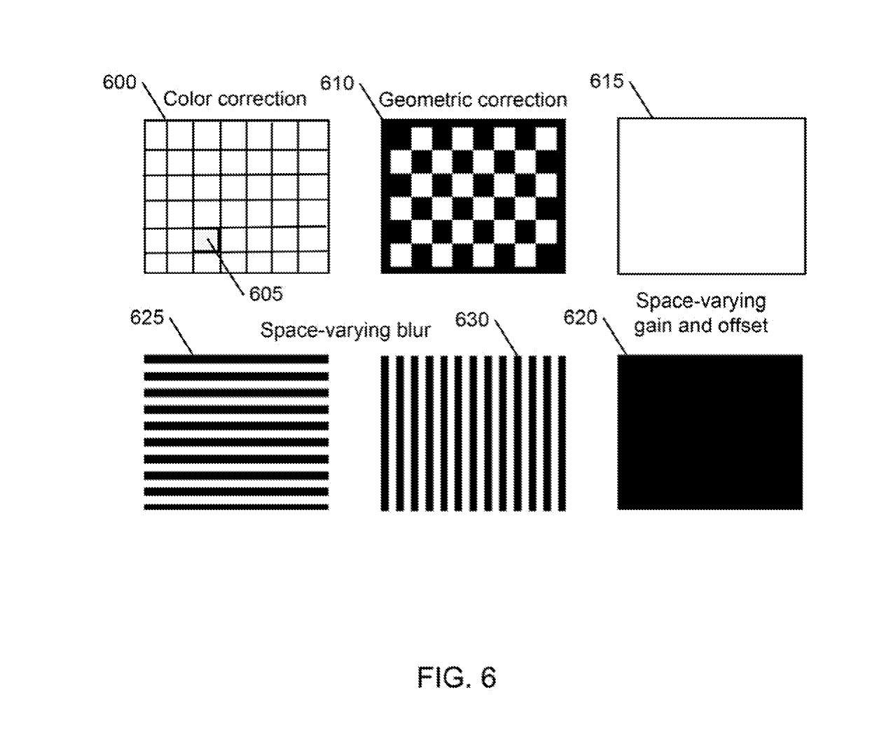

FIG. 6 illustrates example test signals that may be used to generate the forward transformation model of FIG. 5. Test signal 600 represents a color patch having multiple color squares, such as square 605, and is used for the color correction 510. Test signal 610 is a checkerboard used for the geometric correction 515, and the white and black with signals 615-620 are used for the space-varying gain and offset transformation 505. The test signals 625-630 contain horizontal and vertical lines to determine the space-varying blur parameters.

As appreciated by one skilled in the art, other test signals may be used to generate the forward transformation model described herein. It is also appreciated that the care taken in including various transformations to generate the forward transformation model. enables the cross-talk reduction module of FIG. 3 to reduce and correct for cross-talk in any type of 3D display and for a wide range of input signals, while improving the visual quality of the displayed signals.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope a the disclosure. Thus, the present disclosure is not intended to be limited to the embodiments shown herein but is to be accorded the widest scope consistent with the principles and novel features disclosed herein.

What is claimed is:

1. A method for reducing cross-talk in a 3D display, the method comprising:
characterizing the cross-talk in the 3D display with at plurality of test signals to generate a forward transformation model;
applying input image signals to the forward transformation model to generate modeled signals;
applying the modeled signals to a visual model to compute a visual measure; and
modifying the input image signals based on the visual measure.

2. The method of claim 1, wherein characterizing the cross-talk in the 3D display comprises inputting the plurality of test signals into the 3D display and measuring a set of output signals.

3. The method of claim 2, further comprising using the set of output signals to generate the forward transformation model.

4. The method of claim 1, wherein the plurality of test signals comprise signals from the group consisting of a color patch test signal, a checkerboard test signal, a white test signal, a black test signal, a horizontal lined test signal, and a vertical lined test signal.

5. The method of claim 1, wherein the forward transformation model comprises a set of transformations from the group consisting of a space-varying offset and gain transformation, a color correction transformation, a geometric correction transformation, and a space varying blur transformation.

6. The method of claim 1, wherein the modeled signals comprise a set of cross-talk modeled signals and a set of desired signals.

7. The method of claim 1, wherein the visual measure comprises a visual differences measure between the cross-talk modeled signals and the desired signals.

8. The method of claim 1, wherein modifying the input image signals based on the visual measure comprises generating visually modified input signals.

9. The method of claim 8, wherein generating visually modified input signals comprises varying visual characteristics of the input image signals to generate the visually modified input signals as canonical transformations of the input image signals.

10. The method of claim 8, further comprising minimizing the visual measure.

11. The method of claim 10, wherein minimizing the visual measure comprises applying the visually modified input signals to the forward transformation model to generate a new set of modeled signals and applying the new set of modeled signals to the visual model to update the visual measure until it is minimized.

12. A 3D display system, comprising
a 3D display screen; and
a cross-talk reduction module to reduce cross-talk introduced by the 3D display screen, the cross-talk reduction module comprising:
a forward transformation model to model the cross-talk introduced by the multiview display screen and generate modeled signals from input image signals;
a visual model to compute a visual measure; and
a cross-talk correction module to modify the input image signals based on the visual measure.

13. The 3D display system of claim 12, wherein the forward transformation model comprises a set of transformations from the group consisting of a space-varying offset and gain transformation, a color correction transformation, a geometric correction transformation, and a space varying blur transformation.

14. The 3D display system of claim 13, wherein the modeled signals comprise a set of cross-talk modeled signals and a set of desired signals.

15. The 3D display system of claim 12, wherein the visual measure comprises a visual differences measure between the cross-talk modeled signals and the desired signals.

16. The 3D display system of claim 12, wherein the cross-talk correction module generates visually modified input signals.

17. The 3D display system of claim 16, wherein the cross-talk correction module generates the visually modified input signals as canonical transformations of the input image signals by varying visual characteristics of the input image signals.

18. The 3D display system of claim 17, wherein the visually modified input signals are applied to the forward transformation model to generate a new set of modeled signals and the new set of modeled signals are applied to the visual model to update the visual measure until it is minimized.

19. A cross-talk reduction module for use with a 3D display, the cross-talk reduction module comprising:
a forward transformation model to model cross-talk introduced by the 3D display and generate modeled signals from input image signals;
a visual model to compute a visual measure; and
a cross-talk correction module to modify the input image signals based on the visual measure.

20. The cross-talk reduction module of claim 19, wherein the visual measure is minimized until the cross-talk introduced by the 3D display is visually reduced to a viewer.
